(19) United States
(12) Patent Application Publication
(10) Pub. No.: US 2011/0255511 A1
(43) Pub. Date: Oct. 20, 2011

(54) HANDOVER METHOD AND MOBILE TERMINAL AND HOME AGENT UTILIZED IN SAID METHOD

(75) Inventor: Shinkichi Ikeda, Kanagawa (JP)

(73) Assignee: PANASONIC CORPORATION, Osaka (JP)

(21) Appl. No.: 13/141,115

(22) PCT Filed: Dec. 22, 2009
(86) PCT No.: PCT/JP2009/007117

§ 371 Date: Jun. 21, 2011

(30) Foreign Application Priority Data
Dec. 22, 2008 (JP) 2008-325606

(51) Int. Cl. H04W 36/00

(52) U.S. Cl. 370/331

(57) ABSTRACT

A technology is disclosed that provides a handover method and the like capable of improving communication efficiency by detecting that a handover destination network is a home link at an early stage and reducing tunnel overhead between a mobile node and a home agent. The technology includes, when the mobile node performs a handover from an access router of a network before the handover to which the mobile node is currently connected, to an access router of another network that is a handover destination: a step of transmitting, by a mobile node 107, an address allocation request message for acquiring an address in the handover destination network allocated to the mobile node, to the access router of the handover destination; and a step of transmitting, by a home agent 106 of the mobile node, a notification message including information indicating a type of the address of the mobile node allocated by an address allocation server of the handover destination or the home agent as a result of the address allocation request message, to the mobile node via the access router before the handover.

### TECHNICAL FIELD

The present invention relates to a handover method in a communication system in which communication is performed while moving between networks supporting different IP versions, and a mobile terminal and a home agent (location management server) used in the method.

### BACKGROUND ART

As mobility management protocol for a mobile terminal (equivalent to mobile node) performing internet protocol communication (IP communication) in conventional mobile communication systems, Mobile IPv4 (MIPv4) or Mobile IPv6 (MIPv6) has been used. Details of these technologies are respectively disclosed in Non-patent Document 1 and Non-patent Document 2, below. In addition, conventionally, Dual Stack Mobile IP (DSMIP) has been used that expands MIPv6 operating only in access networks supporting IPv6 to also operate in access networks supporting only IPv4. Details of this technology are disclosed in Non-patent Document 3.

In MIPv6 protocol based on Non-patent Document 2, a mobile node registers an IPv6 home address (HoAv6) and an IPv6 care-of address (CoAv6) in a home agent (location management server), and the home agent manages correlation (binding) of the addresses. However, all messages are based on IPv6 protocol and can only be used from accesses networks supporting IPv6. DSMIP is an extension of MIPv6. When the mobile node attaches to an access network supporting only IPv4, the DSMIP enables the mobile node to communicate using the HoAv6 even from the access network supporting only IPv4 by binding an IPv4 care-of address (CoAv4) acquired from the access network with the HoAv6.

Furthermore, under a premise that the home agent has an IPv4 address, the DSMIP enables exchange of binding control messages (such as binding update (BU) and binding acknowledge (BA) messages) based on MIPv6 by encapsulating the CoAv4 and the IPv4 address of the home agent by an IPv4 header written in an address field. Moreover the DSMIP enables the mobile node to communicate with a correspondent node (CN) having only an IPv4 address by allocating an IPv4 home address (HoAv4) to the mobile node.

A method of enabling MIPv6-based binding management of a mobile node attached to an access network supporting only IPv4 is also disclosed in Patent Document 1, below. A handover method using similar technology is being studied for use in mobile communication systems for mobile phones, as well. In Non-patent Document 4, below, a method of performing a handover from a 3GPP access network (such as LTE) to a non-3GPP access network (such as a wireless LAN network system, a WiMAX network system, or a 3GPP2 network system) using DSMIP is disclosed.

In the above-described conventional technologies, the mobile node only performs home link detection regarding an IPv6 home prefix to which the home address HoAv6 belongs. In other words, the mobile node does not perform home link detection using the IPv4 address. Even when the subnet of the IPv4 address (equivalent to the CoAv4) acquired from the access network and the subnet of the HoAv4 are the same, the mobile node does not consider the access network to be a home link so long as the IPv6 prefix acquired from the access network and the IPv6 home prefix are not the same.

Therefore, even when the access network can actually be a home link from the perspective of the IPv4 subnet, an IPv4 tunnel header is required to be additionally added to all packets (binding control messages and user data) when the mobile node is using the HoAv4. As a result, header overhead increases, and a problem occurs in that communication efficiency decreases particularly in a wireless communication system in which a plurality of mobile nodes share a limited communication bandwidth.

Here, a challenge faced by conventional mobile communication systems will be described in detail with reference to FIG. 1 and FIG. 13. FIG. 1 is a configuration diagram of an example of a mobile communication system using DSMIP in which an access network 101 supporting IPv6, an access network 102 supporting only IPv4, and a core network 103 to which connection can be made via the access networks are arranged. Access routers AR 104 and AR 105 are respectively deployed in the access networks. Each access router is an IPv6 router or an IPv4 router depending on operation of the access network system.

A home agent HA 106 based on DSMIP is deployed in the core network 103. A mobile node UE 107 connects to the HA 106 via the access network 101 and acquires the IPv6 home address (HoAv6). Subsequently, the mobile node UE 107 moves to the access network 102 and performs a handover process.

FIG. 13 is a sequence chart for explaining an example of a conventional handover process procedure. The mobile node UE 107 detects handover to the access network 102 (Step S1301) being initiated and starts an attach process (Step S1302). The attach process includes an attachment authentication process by an authentication server HSS/AAA 1301 (Step S1303) and is completed when the attachment is approved. The UE 107 then acquires the IPv4 address using DHCP protocol or the like (IPv4 address allocation request and IPv4 address allocation: Steps S1304 and S1305) and transmits a binding request message (binding update: BU) to register in the HA, the acquired IPv4 address as a care-of address (CoAv4) with the HoAv6 that has already been acquired (Step S1306).

At this time, the UE 107 performs an IPv4 home address (HoAv4) allocation request according to the DSMIP protocol using the BU. When the HA 106 receives the BU including the HoAv4 allocation request, the HA 106 registers the HoAv6 and CoAv4 pair in the binding cache, and provides indication to the UE 107 using a binding response message (binding acknowledgement: BA) to allocate the HoAv4 (Step S1307). In addition, the HA 106 registers the HoAv4 and CoAv4 pair to the binding cache.

Here, through comparison of the subnet sections of the acquired HoAv4 and CoAv4, the UE 107 is able to perform home link detection from the perspective of the IPv4 subnet (Step S1308) that has not been performed in the past. As a result, when the subnet sections of the HoAv4 and the CoAv4 are identical, the UE 107 can deem the access network 102 to be a home link from the IPv4 perspective, and a redundant IPv4 tunnel header is no longer required to be attached to the packets exchanged with the HA 106.

If the subnet sections are not identical, the access network 102 is not a home link. Therefore, the IPv4 tunnel header is required to be attached to all packets exchanged with the HA 106. Conventionally, the IPv4 tunnel header has been attached to all packets exchanged with the HA 106 because home link detection from the IPv4 perspective is not performed.

Here, reducing header overhead by not attaching the IPv4 tunnel header in any instance is ideal. In typical wireless communication systems, the link between the mobile node and the AR is configured by a point-to-point link. Therefore, even when one AR accommodates a plurality of mobile nodes, an IPv4 address belonging to different subnets can be allocated to each mobile node.

In addition, the mobile node may perform a key update process, such as that shown in FIG. 13, with the HA, from the acquisition of the CoAv4 until the transmission of the BU. For example, a mobile node not supporting dynamic key update is required to update a key every time when the care-of address is changed. Key update requires a time-consuming process involving calculations for encryption in both the mobile node and the HA. Therefore, a considerable amount of time is required until the mobile node completes the home link detection from the IPv4 perspective and actually transmits and receives packets.

In Patent Document 2, to solve the above-described issues, a MAG (equivalent to the AR 105), an attach point, acquires terminal capability information from the mobile node when the mobile node attaches to an access network supporting the PMIP protocol. Furthermore, the MAG decides the mobility protocol (DSMIP, PM IP, MIPv4, and the like) provided by the network to the mobile node, based on the acquired terminal capability information, and notifies the mobile node of IP setting information based on the decided protocol. The mobile node is able to know the decided mobility protocol from the IP setting information of which notification has been given and the like. When the decided mobility protocol is PMIP, the IP address acquired in accompaniment can be recognized as being the home address.

### PRIOR ART DOCUMENT

### Patent Document

Patent Document 1: Japanese Patent Application Publication No. 2005-73271 (Abstract)

Patent Document 2: International Application Publication WO 2008-99802 (Abstract)

### Non-Patent Document

Non-patent Document 1: C. Perkins, “IP Mobility Support for IPv4”, IETF RFC3344, August 2002

Non-patent Document 2: D. Johnson, C. Perkins, and J. Arkko, “Mobility Support in IPv6”, IETF RFC3775, June 2004

Non-patent Document 3: Hesham Soliman, “Mobile IPv6 Support for Dual Stack Hosts and Routers (DSMIP)”, draft-ietf-mext-nemo-v4traversal-05.txt, July 2008

Non-patent Document 4: “Architecture enhancements for non-3GPP accesses (Release 8)”, 3GPP TS23.402 v.8.2.0, p.136 to 139, June 2008

However, in the above-described conventional technologies, the notification by which the mobile node discovers that the home address has been acquired is directly acquired from the handover destination access network (MAG in the above-described Patent Document 2) with which the attach process is being performed or with which the mobile node has just been attached. Here, the handover destination access network of the mobile node is equivalent to various access types and network systems, and it is assumed that the operator managing and operating the handover destination access network is not uniform. In other words, the mobile node realistically never expect to acquire the above-described notification in all access networks to which the mobile node may become attached since a complete overhaul from an old system to a new system occurs particularly in the initial stage of system implementation. To achieve the aim of next-generation networks, to enable the mobile node to generally use the desired core network resources by a common procedure while connecting to various access networks, an environment is required to be provided that allows the mobile node to receive services equally without restrictions of diverse management and operation policies.

In this way, from the perspective of diverse management and operation policies, it can be considered almost impossible to expect notification function such as that described above to be supported by all access networks, such as WiMAX, WLAN, 3GPP, and 3GPP2, worldwide. In such instances as well, a method allowing the mobile node early to complete home link detection from the IPv4 perspective is required.

### SUMMARY OF THE INVENTION

In light of the above-described issues, in a mobile communication system using DSMIP, when a mobile node having only an IPv6 home address performs a handover to an access network supporting only IPv4, notification of the type of IP address (home address or care-of address) allocated to the mobile node in the handover destination network is provided from the home agent to the mobile node via the handover source network, and the mobile node performs home link detection in adherence to a notification acquisition timing. As a result, an object of the present invention is to provide a handover method, and a mobile node and a home agent used in the handover method, in which communication efficiency can be improved by early detecting that the handover destination access network is the home link and reducing tunnel overhead between the mobile node and the home agent. In addition, even in an instance in which the mobile node performs a key update process, home link detection can be completed before the key update process, and packets can be transmitted and received without waiting for the time-consuming key update process to be completed.

To achieve the above-described object, the present invention provides a handover method for a mobile node that moves between at least two networks each supporting a different, unique IP version that is a communication protocol of the mobile node in which, when the mobile node performs a handover from an access router before the handover to which the mobile node is currently connected, to an access router of another network of a handover destination, the handover method includes the steps of: transmitting, by the mobile node, an address allocation request message for acquiring an address in the handover destination network allocated to the mobile node, to the access network of the handover destination; and transmitting, by a home agent of the mobile node, a notification message including information indicating a type of the address of the mobile node allocated by an address allocation server of the handover destination or the home agent as a result of the address allocation request message, to the mobile node via the access router before the handover. As a result of the configuration, communication efficiency can be improved by detecting that the handover destination access network is a home link at an early stage and reducing tunnel overhead between the mobile node and the home agent. In addition, even when the mobile node performs a key update process, home link detection can be performed before the key update process, and packets can be transmitted and received without waiting for completion of the time-consuming key update process. Handover time can be reduced.

In addition, the present invention provides a mobile node that performs a handover between at least two networks each supporting a different, unique IP version that is a communication protocol of the mobile node in which, when the mobile node performs a handover from an access router before the handover to which the mobile node is currently connected to an access router of another network of a handover destination, the mobile node includes: a message generating means for generating an address allocation request message for acquiring an address in the network of the handover destination allocated to the mobile node; a transmitting means for transmitting the generated address allocation request message to the access router of the handover destination; and a receiving means for receiving, from a home agent of the mobile node via the access router before the handover, a notification message including information indicating a type of the address of the mobile node allocated by the address allocation server of the handover destination or the home agent as a result of the address allocation request message. As a result of the configuration, communication efficiency can be improved by detecting that the handover destination access network is a home link at an early stage and reducing tunnel overhead between the mobile node and the home agent. In addition, even when the mobile node performs a key update process, home link detection can be performed before the key update process, and packets can be transmitted and received without waiting for completion of the time-consuming key update process. Handover time can be reduced.

In addition, the present invention provides a home agent of a mobile node that performs a handover between at least two networks each supporting a different, unique IP version that is a communication protocol of the mobile node in which, when the mobile node performs a handover from an access router before the handover to which the mobile node is currently connected, to an access router of another network of a handover destination, the home agent includes: a message generating means for generating a notification message inducing information indicating a type of an address of the mobile node allocated by an address allocating sever of the handover destination or the home agent, based on an address allocation request message for acquiring an address in the network of the handover destination allocated to the mobile node; and a transmitting means for transmitting the generated notification message to the mobile node via the access router before the handover. As a result of the configuration, communication efficiency can be improved by detecting that the handover destination access network is a home link at an early stage and reducing tunnel overhead between the mobile node and the home agent. In addition, even when the mobile node performs a key update process, home link detection can be performed before the key update process, and packets can be transmitted and received without waiting for completion of the time-consuming key update process. Handover time can be reduced.

The handover method, and the mobile node and the home agent used in the method improve communication efficiency by early detecting that the handover destination access network is a home link and by reducing tunnel overhead between the mobile node and the home agent. In addition, even when the mobile node performs a key update process, home link detection can be performed before the key update process, and packets can be transmitted and received without waiting for completion of the time-consuming key update process. As a result, the handover time can be reduced. In addition, through use of DSMIP connection already established via the handover source access network, even when the handover destination access network does not have a function for directly notifying the mobile node, desired operations can be performed.

### BRIEF DESCRIPTION OF THE DRAWINGS

FIG. 1 is a configuration diagram of an example of a configuration of a communication system according to an embodiment of the present invention;

FIG. 2 is a sequence chart for explaining an example of a handover method according to the embodiment of the present invention;

FIG. 3 is another sequence chart for explaining an example of the handover method according to the embodiment of the present invention;

FIG. 4 is another sequence chart for explaining an example of the handover method according to the embodiment of the present invention;

FIG. 5 is another sequence chart for explaining an example of the handover method according to the embodiment of the present invention;

FIG. 6 is a configuration diagram of an example of a configuration of a mobile node according to the embodiment of the present invention;

FIG. 7 is a flowchart of an example of a process flow in the mobile node according to the embodiment of the present invention;

FIG. 8 is a flowchart of another example of a process flow in the mobile node according to the embodiment of the present invention;

FIG. 9 is a flowchart of another example of a process flow in the mobile node according to the embodiment of the present invention;

FIG. 10 is a configuration diagram of an example of a configuration of a home agent according to the embodiment of the present invention;

FIG. 11 is a flowchart of an example of a process flow in the home agent according to the embodiment of the present invention;

FIG. 12 is a flowchart of another example of a process flow in the home agent according to the embodiment of the present invention; and

FIG. 13 is a diagram for explaining a conventional technology.

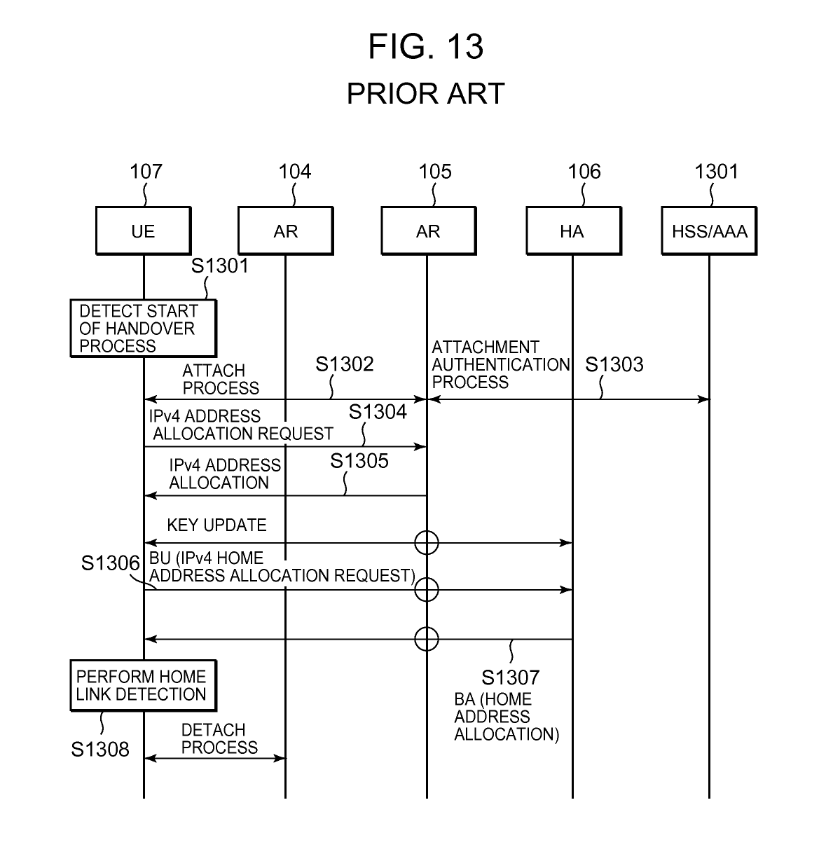

### DESCRIPTION OF EMBODIMENTS

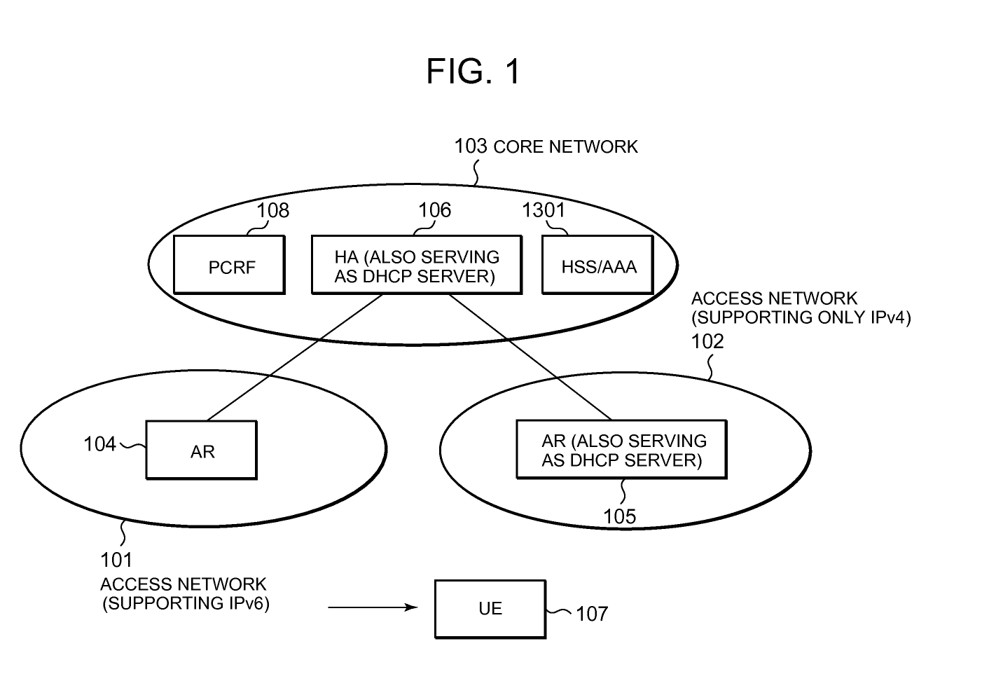

Specific operations according to an embodiment of the present invention will be described. FIG. 1 is a diagram for explaining a system configuration according to the embodiment of the present invention, in which an access network 101 supporting at least IPv6, an access network 102 supporting only IPv4, and a core network 103 to which connection can be made via the access networks are arranged. Access routers AR 104 and AR 105 are respectively deployed in the access networks. Each access router is an IPv6 router or an IPv4 router, or both, depending on operation of the access network system. In the core network 103, a policy control and charging rules function (PCRF) server 108 is deployed that performs control related to the quality of service (QoS) of the overall system and the like based on attachment request from a mobile node 107.

More specifically, depending on the standard used by the access network, the access router may be referred to as an access gateway (AGW), a mobility anchor gateway (MAG), a packet data gateway (PDG) or enhanced packet data gateway (ePDG), a serving gateway (SGW), a serving GPRS serving node (SGSN) or the like. A home agent (HA) 106 based on DSMIP is deployed in the core network 103. Depending on the standard used by the core network 103, the HA 106 may be referred to as a packet data network gateway (PDN GW), a gateway GPRS serving node (GGSN), or the like.

In FIG. 1, a mobile node UE 107 connects to the HA 106 via the access network 101 and acquires an IPv6 home address (HoAv6). The mobile node UE 107 then moves to the access network 102 and performs a handover process.

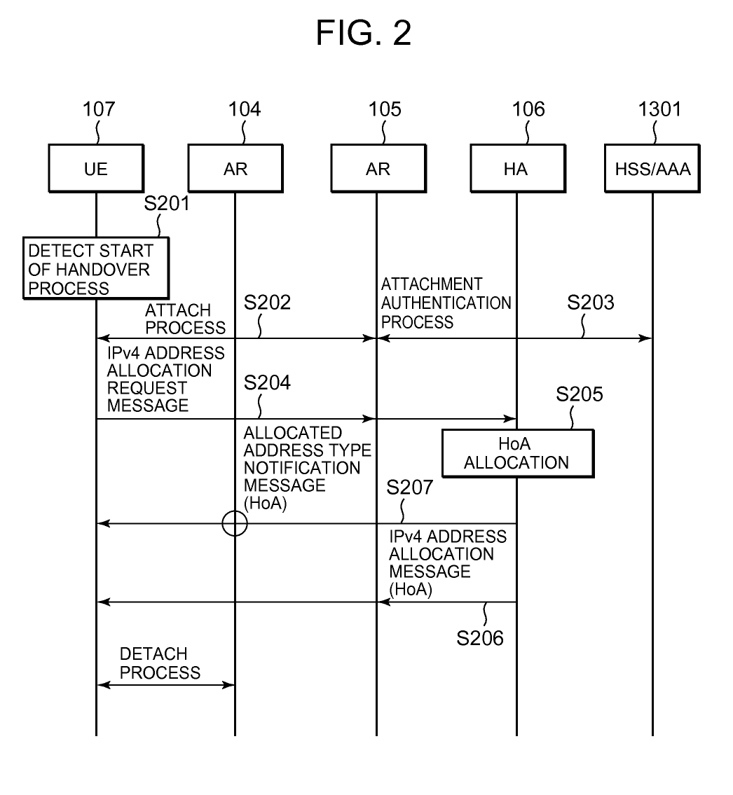

FIG. 2 is a sequence chart for explaining an example of a handover method according to the embodiment of the present invention. When the mobile node UE 107 detects the handover to the access network 102 (Step S201), the UE 107 starts an attach process to an attach point (AR 105, herein) of the access network 102 (Step S202). During the attach process, the AR 105 requests that HSS/AAA 1301 perform an attachment authentication process regarding the UE 107 (Step S203). When the attachment authentication process is successful, the AR 105 performs an associated process and completes the attach process.

When an IP address is not allocated through the attach process or when an instruction is provided from the network, the UE 107 acquires an IPv4 address using a protocol such as DHCP. In other words, the UE 107 transmits an IPv4 address allocation request message to the AR 105 (Step S204). Here, when the requested IP address is allocated by the core network 103, or in other words, when a DHCP relay function in the AR 105 is enabled, the IPv4 address allocation request message is transferred from the AR 105 to the HA 106. The HA 106 receives the request and allocates a home address (Step S205). Then, the HA 106 notifies the UE 107 using an IPv4 address allocation message (Step S206).

In addition, when the AR 105 functions as an MAG and mobility function between the AR 105 and the HA 106 is actualized using PMIP protocol, the AR 105 (MAG) may receive the IPv4 address allocation request message from the UE 107 and issue a proxy binding update (PBU) to the HA 106. In this instance as well, the HA 106 similarly allocates a home address, and notifies the AR 105 of the home address using a proxy binding acknowledge (PBA) message that is a response to the PBU. The AR 105 then notifies the UE 107 of the allocated home address using the IPv4 address allocation message.

Here, the HA 106 confirms that the received address allocation request message is from the UE 107 in the following manner. The AR 105 associates an identifier (such as a network access identifier [NAI]) of the UE 107 acquired during the attach process with a communication bearer established by the attach process (for example, so that a bearer ID is allocated in a 3G access system), and the identifier is stored. The address allocation request message transmitted by the UE 107 is transferred over the communication bearer established by the attach process. Therefore, the AR 105 identifies the received address allocation request message as that transmitted from the UE 107, and acquires the identifier (such as the NAI) of the UE 107 stored earlier.

The AR 105 writes the identifier (NAI) of the UE 107 in the address allocation request message or the PBU, and transfers or transmits the address allocation request message or the PBU to the HA 106. A “client field” for writing the NAI is provided in the DHCP message, and an option for writing the NAI is similarly provided in the PBU. The HA 106 receives the message in which the identifier (NAI) of the UE 107 is written and can recognize the message as that transmitted from the UE 107. Alternatively, the UE 107 includes its own identifier in the message and transmits the message, thereby eliminating the need for the AR 105 to perform identification.

The HA 106 notifies the UE 107 of the allocated IP address, and at the same time, transmits an allocated address type notification message via the handover source access network using DSMIP binding information (pieces of information such as a home address and a care-of address collected in the binding cache) for the UE 107 to which connection has already been established (Step S207), to notify the UE 107 that the allocated IP address is the home address. As the allocated address type notification message, for example, a binding revocation request, a binding refresh request, or a binding acknowledgement may be used. Alternatively, an original message may be used.

In addition, a value of the allocated home address may be written in the allocated address type notification message. However, a flag (at least one bit) simply indicating whether the allocated address is a home address or a care-of address may be attached. As a result of only a flag being transmitted, notification of the desired information can be provided to the UE 107 using a small number of bits compared to when the value of the address is transmitted, and communication resources can be effectively used.

The UE 107 that has received the allocated address type notification message confirms that the IP address acquired in the handover destination network is the home address, or in other words, the handover destination access network is the home link. In other words, matching of subnets between the home address acquired during the binding process (BU/BA exchange) that is originally subsequently performed and the address acquired earlier, namely home link detection, can be omitted. When a key update process is required to be performed before the binding process, in particular, a key exchange process can be omitted or delayed, and handover time can be reduced. A reason for this is that, although the key update process is required to be performed before the BU/BA exchange is performed (because its purpose is to update an IPsec key for protecting the BU/BA), the key update process can be performed at an arbitrary timing after completion of the handover process as a result of the BU/BA exchange being omitted.

The AR 105 may provide a function as an MAG, the mobility function between the AR 105 and the HA 106 may be actualized using PMIP protocol, and PBU/PBA may have already been exchanged between the HA 106 and the MAG during the attach process. Furthermore, at this time, the UE 107 may be notified of the allocated IP address during the attach process, or the UE 107 may not be notified during the attach process while the allocated IP address is held by the MAG. In the latter instance, the UE 107 is notified of the allocated address by an address acquisition process using DHCP or the like that is subsequently performed.

In all of these instances, home address allocation by the HA 106 is performed during the attach process. Therefore, the HA 106 can transmit the allocated address type notification message simultaneously with the completion of home address allocation performed during the attach process. In the UE 107 as well, the address type notification can be received via the handover source access network during the attach process or at almost the same timing as the completion of the attach process. The UE 107 can also be notified of the value of the allocated address through the address type notification message. When the UE 107 is not notified of the address during the attach process, the address acquisition process using DHCP or the like becomes unnecessary.

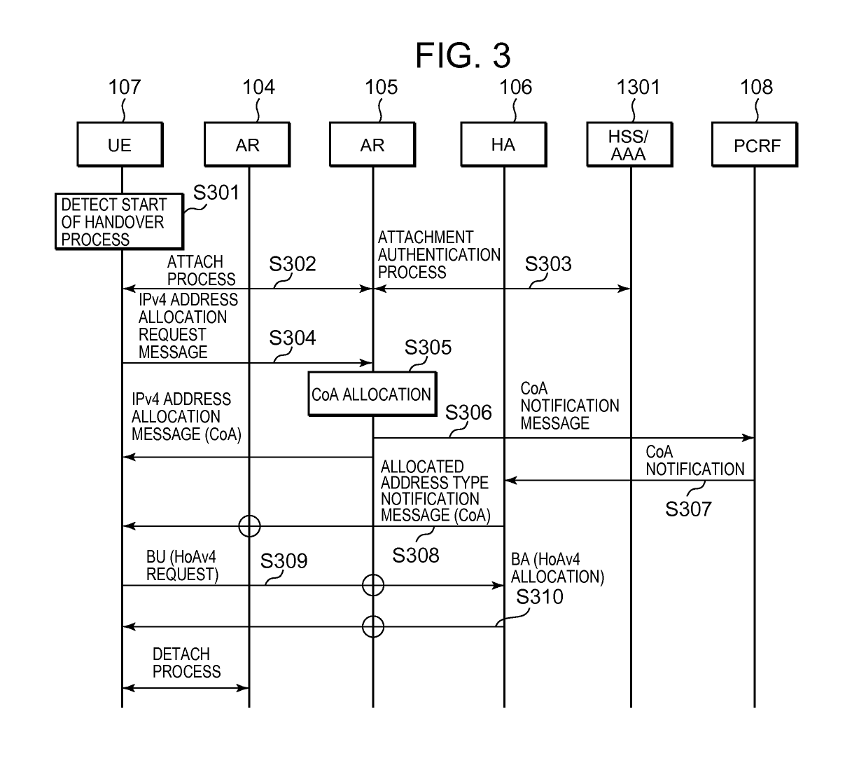

Next, operations performed when a care-of address is allocated in the handover destination access network will be described. FIG. 3 is a sequence chart for explaining an example of a handover method according to the embodiment of the present invention. When the mobile node UE 107 detects the handover to the access network 102 (Step S301), the UE 107 starts an attach process to an attach point (AR 105, herein) of the access network 102 (Step S302). During the attach process, the AR 105 requests that the HSS/AAA 1301 perform an attachment authentication process regarding the UE 107 (Step S303). When the attachment authentication process is successful, the AR 105 performs an associated process and completes the attach process.

Here, because the allocated address is a care-of address (CoA) rather than the home address (HoA), or in other words, the access network 102 can allocate an address, the IP address allocation request message (Step S304) transmitted by the UE 107 is processed by a server within the access network 102 (such as a DHCP server that may also be provided within the AR 105, as described hereafter). In other words, the care-of address is allocated to the UE 107 (Step S305). When the care-of address is allocated to the UE 107, in preparation for QoS policy application when the UE 107 subsequently performs a binding (and thus, to enable communication using core network resources), the AR 105 notifies the PCRF server 108 of the allocated care-of address (Step S306: CoA notification message). The CoA notification message is also referred to as gateway control session establishment, gateway control and QoS rules request, gateway control and QoS rules provision, and the like. When the AR 105 is provided in a roaming network, or in other words, when the UE 107 attaches to a roaming network, the CoA notification message is delivered to a proxy PCRF server provided in the roaming network and transferred to the PCRF server 108 of the core network 103.

The PCRF server 108 that has received the CoA notification message transfers the received CoA notification message to the HA 106 or simply notifies the HA 106 that a care-of address has been allocated to the UE 107 to enable the HA 106 to transmit the allocated address type notification message to the UE 107 (Step S307: CoA notification). In other words, when the care-of address of the UE 107 is allocated by the AR 105 of the handover destination, the HA 106 receives information indicating the type of the address allocated by the AR 105 of the handover destination from the PCRF server 108. Upon receiving the information, the HA 106 transmits the allocated address type notification message to the UE 107 via the handover source access network (Step S308), to notify the UE 107 that a care-of address has been allocated.

Here, the PCRF server 108 and the HA 106 confirm that the received address allocation request message is from the UE 107 in the following manner. The AR 105 associates the identifier (such as the network access identifier [NAI]) of the UE 107 acquired during the attach process with a communication bearer established by the attach process (for example, so that a bearer ID is allocated in a 3G access system), and the identifier is stored. The address allocation request message transmitted by the UE 107 is transferred over the communication bearer established by the attach process. Therefore, the AR 105 identifies the received address allocation request message as that transmitted from the UE 107, and acquires the identifier (such as the NAI) of the UE 107 stored earlier.

The AR 105 writes the identifier (NAI) of the UE 107 in the address allocation request message or the PBU, and transfers or transmits the address allocation request message or the PBU to the HA 106. A “client field” for writing the NAI is provided in the DHCP message, and an option for writing the NAI is similarly provided in the PBU. The PCRF server 108 and the HA 106 receive the message in which the identifier (NAI) of the UE 107 is written, and can recognize the message as that transmitted from the UE 107. Alternatively, the UE 107 includes its own identifier in the message and transmits the message, thereby eliminating the need for the AR 105 to perform identification.

The UE 107 that has confirmed that a care-of address has been allocated registers the acquired care-of address in the HA 106, and starts communication over an external link. At this time, when the UE 107 has not acquired an IPv4 home address, the IPv4 home address is required to be newly acquired during the binding process with the HA 106 (BU/BA exchange: Steps S309 and S310). However, the UE 107 can receive notification of the IPv4 home address from the HA 106 using the allocated address type notification message received earlier. In this instance, the UE 107 may request notification in advance from the HA 106 by a binding procedure or the like (namely by using a binding update message or the like).

In addition, the UE 107 may send a request message (such as a BU message to which a flag requesting the IPv4 home address is added) via the handover source access network to the HA 106 simultaneously with the attach process to the handover destination access network. In response, the HA 106 may transmit the allocated address type notification message (such as a BA message in which the IPv4 home address is written) to the UE 107. As a result, the home address can be acquired on a parallel with the attach process and the address acquisition process, and the subsequent binding process is no longer necessary. The time of the overall handover can be reduced.

The UE 107 may be provided notification of the care-of address during the attach process in this instance as well. In this instance, transmission of the CoA notification message from the AR 105 to the PCRF server 108 is performed during the attach process. Therefore, the HA 106 can receive the content (that a CoA has been allocated to the UE 107) transferred from or notified from the PCRF server 108 during the attach process, and can transmit the allocated address type notification message. As a result, in the UE 107 as well, the address type notification will be received via the handover source access network during the attach process or at almost the same timing as the completion of the attach process. Because the UE 107 has already acquired the IP address, transmission of the IP address allocation request using DHCP and the like is not required.

Here, in the description above, the destination node to which the AR 105 transmits the CoA notification message is the PCRF server 108. However, the destination may be another node, such as the HSS/AAA server 1301. Alternatively, a CoA notification message or a message including an equivalent piece of information may be transmitted directly to the HA 106.

As described above, the HA 106 notifies the UE 107 of the type of address (home address or care-of address) allocated to the UE 107 using a communication connection that has already been established (in other words, a DSMIP binding connection of the handover source access network). As a result, even in an instance in which the access network does not have a means for directly notifying the UE 107, prompt home link detection can be made possible.

The HA 106 receives the information related to the type of the allocated address from different routes. In other words, the HA 106 receives the fact that a home address has been allocated from the HA 106 itself, and the fact that a care-of address has been allocated from the AR 105 located in the handover destination access network via a server, such as the PCRF server 108.

The CoA allocation notification is delivered to the HA 106 via the PCRF server 108 after the address has actually been allocated. Therefore, compared to the home address (HoA) allocation notification, a longer delivery time is expected to be required until the UE 107 receives the notification. In other words, when DHCP is used for IP address acquisition, the HoA allocation notification (allocated address type notification message [HoA]) can be delivered immediately after completion of the DHCP process, whereas the CoA allocation notification (allocated address type notification message [CoA]) is expected to reach the UE 107 some time after the completion of the DHCP process.

The UE 107 can take advantage of this characteristic and judge whether the HoA or the CoA has been allocated using the arrival timing of the allocation notification. In other words, for example, a home link judgment control unit 607 of the UE 107 can judge that the HoA has been allocated when the allocated address type notification message is received immediately after the completion of the DHCP process and judge that the CoA has been allocated when the notification is not received. As a result of eliminating the message wait time for CoA allocation in particular, the handover process can be made faster. In this instance, as described hereafter, the HA 106 can notify the UE 107 that the HoA allocation notification has been transmitted via the handover source access network. In other words, the HA 106 can transmit to the UE 107, in addition to the allocated address type notification message, a message including information indicating the type of address allocated to the UE 107. The UE 107 can then receive the message.

However, in the above-described method, or in other words, to judge whether the HoA or the CoA has been allocated based on the reception timing of the allocated address type notification message from the HA 106, a timer for detecting the reception timing of the allocated address type notification message using the completion of the DHCP process as a starting point is required to be newly provided in the UE 107. Therefore, in the present invention, a method is disclosed in which, by optimizing the transmission timing of the HoA allocation notification in the HA 106, the notification content can be certainty determined based on the timing at which the UE 107 receives the notification message.

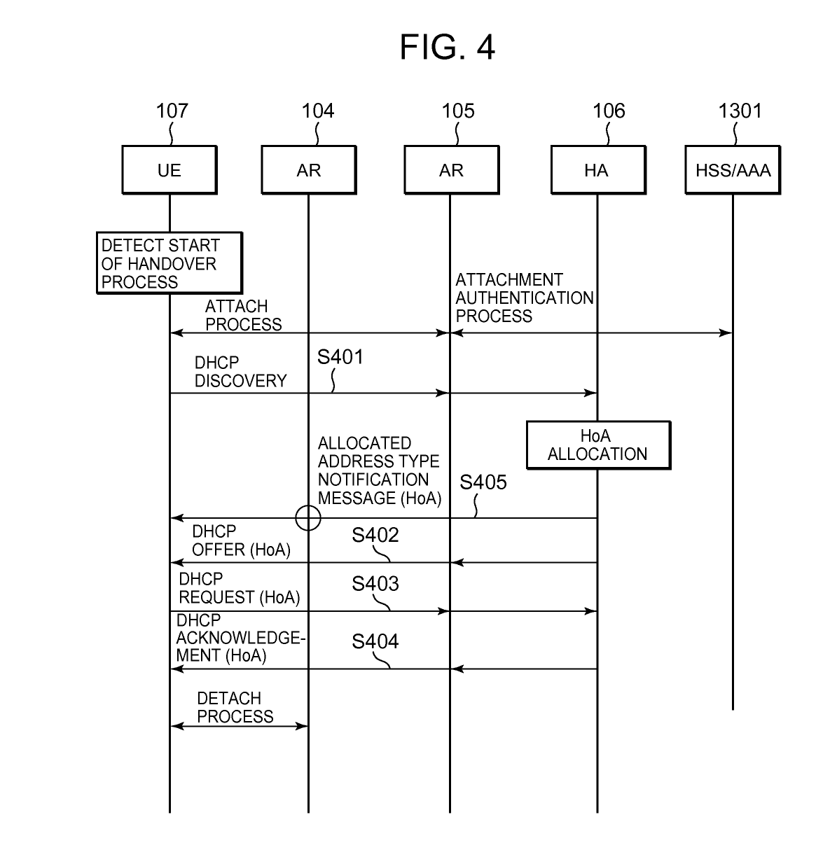

FIG. 4 is a sequence chart for explaining an example of a handover method according to the embodiment of the present invention. In the present invention, focus is placed on the DHCP-based IP address allocation process being configured by a sequence amounting to two reciprocating exchanges. In other words, a conventional DHCP sequence is performed in sequence from DHCP discovery (UE to HA: Step S401), DHCP offer (HA to UE: Step S402), DHCP request (UE to HA: Step S403), to DHCP acknowledgement (HA to UE: Step S404). In a cellular system such as 3GPP, a single DHCP server (equivalent to the HA 106 herein) that allocates an address to the UE 107 is determined. Therefore, because the home address to be allocated to the UE 107 is already decided in the HA 106 at the time of transmission of the DHCP offer, the HoA allocation notification can be transmitted simultaneously with the transmission of the DHCP offer. In other words, the HA 106 can transmit the HoA allocation notification message to the UE 107 simultaneously with the DHCP offer that is a response message for the DHCP discovery.

As a result, the HoA allocation notification transmitted by the HA 106 is delivered to the UE 107 during the DHCP process (allocated address type notification message: Step S405). Therefore, when the allocated address type notification message cannot be received until the completion of the DHCP process, a judgment can be made that the CoA has been allocated. In other words, whether the HoA or the CoA has been allocated can be detected at an early stage (before the DHCP process is completed) without a new timer being provided in the UE 107, and the handover time can be further reduced.

However, in the above-described optimization method, depending on the traffic of the handover source access network and the like, the HoA allocation notification may be delivered to the UE 107 with a delay. In this instance, the UE 107 erroneously recognizes that the CoA has been allocated, and starts the key exchange process or the BU/BA exchange via the handover destination access network. To solve issues such as this, the following two methods can be considered.

A first method is as follows. During the key exchange process or the BU/BA exchange via the handover destination access network, the HA 106 notifies the UE 107 that the HoA allocation notification has been transmitted via the handover source access network. However, the handover destination access network is required to be supporting the protocol for giving notification that the HoA allocation notification has been transmitted during the key exchange process or the BU/BA exchange process. In addition, when the allocated address is actually the HoA, in a worst case scenario, the UE 107 is required to wait for the completion of the key exchange process or the completion of a single reciprocating BU/BA exchange that takes several seconds.

A second method is as follows. After the completion of the DHCP process, the UE 107 starts a timer and waits for a predetermined amount of time because the HoA allocation notification may be received from the HA 106. However, the UE 107 is required to newly include a timer, which increases resources being used (increase in battery consumption and the like become a concern).

Therefore, in the present invention, a method is further disclosed in which, even when a delivery delay occurs in the handover source access network, the HoA allocation notification is delivered to the UE 107 at almost the same timing as the completion of the DHCP process.

In other words, in FIG. 4 described earlier, after the receiving the DHCP offer, the UE 107 transmits the DHCP request after a predetermined delay time, thereby being able to receive with certainty the HoA allocation notification via the handover source access network before the completion of the DHCP process. In other words, after receiving the DHCP offer message, the UE 107 transmits the DHCP request that is a message in response to the DHCP offer message after the elapse of a predetermined amount of time. As a result, the UE 107 can receive the HoA allocation notification with certainty. Here, as the predetermined delay time, for example, a value measured in advance can be configured, such as a transmission delay between the UE 107 and the HA 106 in the handover source access network over which the HoA allocation notification is delivered. Alternatively, a transmission delay can be measured every time communication is performed, and the predetermined delay time can be configured dynamically.

In DHCP protocol, a timer is configured as protocol to enable a predetermined amount of delay to be provided between reception of the DHCP offer and the transmission of the DHCP request. Through use of the above-described method, adjustment of the timing at which the HoA allocation notification is delivered to the UE 107 can be performed using existing resources (protocol timer), without a new timer being added. In addition, because DSMIP connection already established via the handover source access network is used, even when the handover destination access network does not have a function for directly notifying the UE 107, the desired operations can be performed. Furthermore, because the predetermined amount of delay is equivalent to the delivery delay in one direction, the amount of delay is short in relation to the time required for the key exchange processing or the BU/BA exchange.

In the above-described method, system conditions unique to a cellular system, such as 3GPP and 3GPP2 in particular, are used. In other words, because a single DHCP server (equivalent to the HA 106, herein) is decided during network attachment, the allocated address is determined to be that written in the DHCP offer. In other words, the IP address allocated to the UE 107 is already decided when the DHCP offer is transmitted.

Therefore, before the present method is performed, the UE 107 can confirm or presume that the attachment-destination network or the core network is provided by a cellular system, such as 3GPP, or a system meeting the above-described conditions, namely a system in which a single DHCP server can be logically/physically decided as the DHCP server to which the UE 107 issues an inquiry. As a result, when the UE 107 is connecting to a system in which a plurality of DHCP server is present, the UE 107 does not perform the present method. In other words, the UE 107 confirms whether the communication network 103 including the network AR 105 of the handover destination and the handover destination network meets predetermined conditions, and performs the present method when the conditions are met. In other words, the UE 107 waits until the allocated address type notification message is received or adjusts the timing from the reception of the DHCP offer until the transmission of the DHCP request. Confirmation that the attachment is made to a 3GPP network can be judged by 3GPP or an equivalent piece of information (such as an operator name) being included in the network identification section of an identifier of the attachment-destination network (access point name [APN]) of which notification is provided by the UE 107 during attachment.

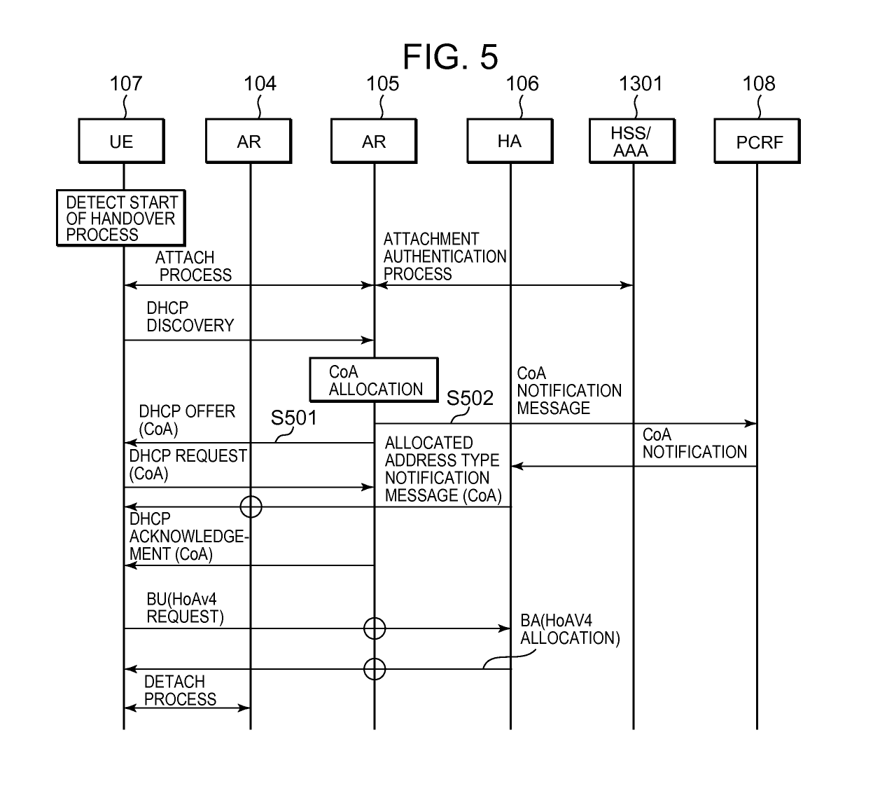

When the CoA is allocated as well, the AR 105 (equivalent to the DHCP server herein) may similarly transmit the CoA allocation notification (Step S502) to the PCRF server 108 at the same timing as the transmission of the DHCP offer (Step S501) (see FIG. 5). In other words, when the CoA is allocated by the AR 105 of the handover destination, the AR 105 of the handover destination transmits the DHCP offer message in place of the HA 106, and at the same time, notifies the PCRF server 108 of the information indicating the type of the allocated address. The HA 106 receives the information indicating the type of the allocated address from the PCRF server 108, and transmits the allocated address type notification message based on the received information.

As a result, the delay until the CoA allocation notification is delivered to the UE 107 can be reduced, and the overall handover time can be reduce particularly when the UE 107 simply judges the HoA/CoA allocation from the content written in the allocated address type notification message. However, unlike when the DHCP server is deployed in the core network 103, an instance can be considered in which a plurality of DHCP servers are deployed in the access network. Therefore, it should be noted that the present method is not necessarily supported in all AR (DHCP servers). In other words, it should not be expected that the present method is supported in all access networks.

A condition of the method of the present invention is that the UE 107 can simultaneously connect to both access networks 101 and 102. Therefore, the UE 107 can notify the HA 106 and other network nodes in advance that the UE 107 supports dual interface by using a BU message or the authentication process message. The HA 106 may then perform the present process based on the state of the dual support (in other words, only during dual support). The notification may be that interface of UE 107 is a single I/F supporting TDD. In addition, the HA 106 may notify the UE 107 of the mobility protocol used on the network side (such as GTP or PM IP) with the HoA notification.

When the handover source access network is 3GPP access, notification of the type of the allocated address (HoA or CoA) may be provided through 3GPP signaling (such as an NAS message) rather than through DSMIP signaling. As a result of 3GPP standard being included, implementation can be promoted, and a wide support area can be secured. In addition, in the above-described example, a handover from an IPv6 access network to an access network supporting only IPv4 is premised. However, in principle, the present invention is similarly applicable to other examples (handover from IPv4 to IPv6) and generalized cases. In other words, a mechanism may be present that provides notification regarding whether the address allocated at the handover destination is the HoA or the CoA.

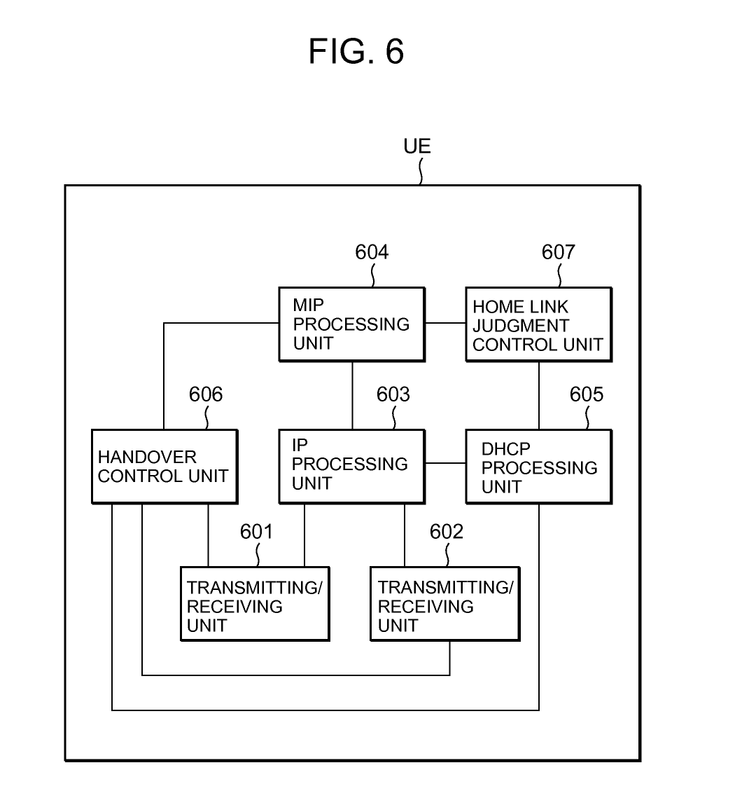

Next, an example of the operations of the mobile node (UE) according to the embodiment of the present invention will be described with reference to FIG. 6 to FIG. 9. FIG. 6 is a configuration diagram for explaining an example of a configuration of the mobile node according to the embodiment of the present invention. Transmitting/receiving units 601 and 602 are equivalent to communication interfaces for respectively attaching to the access networks 101 and 102, and perform a communication protocol process and a modem process of layers below the IP layer. An IP processing unit 603 performs the IP layer process, and an MIP processing unit 604 performs a Mobile IP protocol process based on DSMIP.

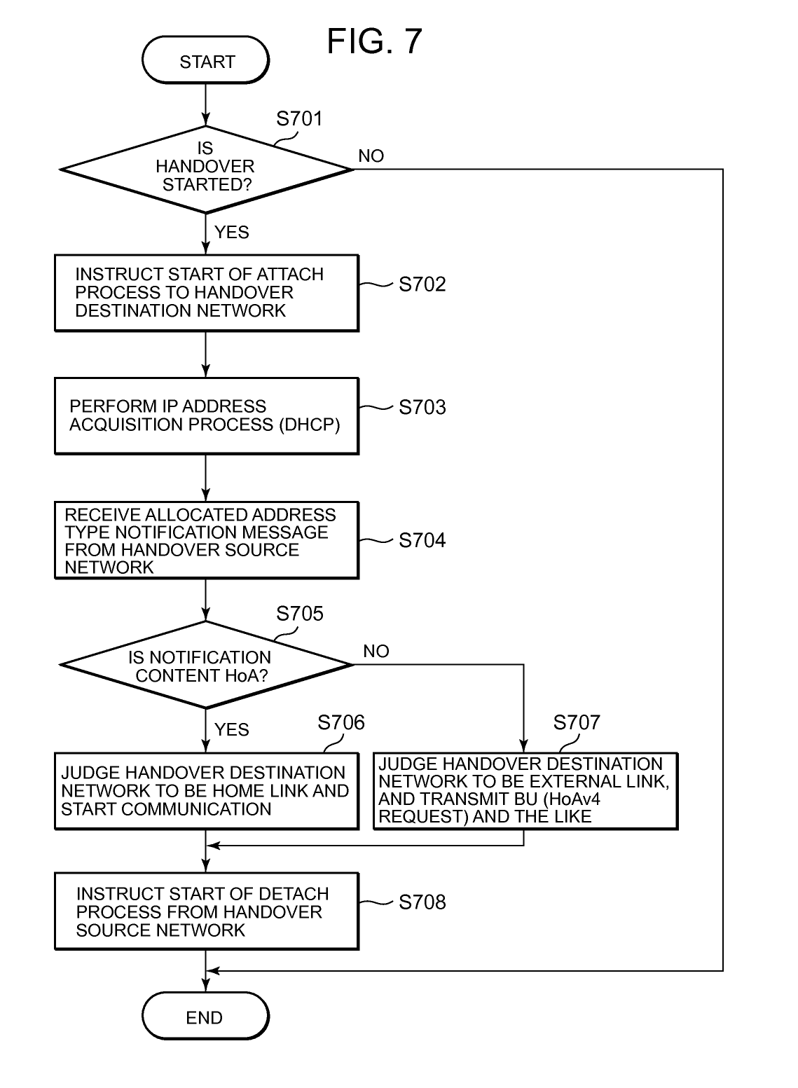

A DHCP processing unit 605 performs a DHCP protocol process (client function). A handover control unit 606 controls the handover process by judging or detecting the possibility of a handover being performed and the timing of the handover based on communication status and the like acquired from the transmitting/receiving units 601 and 602, and sending an instruction for a handover operation to the MIP processing unit 604, the transmitting/receiving units 601 and 602, the DHCP processing unit 605, and the like. A home link judgment control unit 607 is characteristic of the present invention, and an operation thereof will be described with operations of its periphery, with reference to FIG. 7 to FIG. 9.

FIG. 7 is a flowchart of an example of a process flow when the UE 107 judges whether a HoA or a CoA has been allocated based on the content of the allocated address type notification message received from the HA 106. The handover control unit 606 judges whether a handover is started (Step S701). When a judgment is made that a handover is to be performed, the handover control unit 606 instructs the transmitting/receiving unit 602 to start the attach process to the handover destination network (access network 102) (Step S702). When an IP address is not allocated during the attach process and the IP address is acquired using a protocol such as DHCP after completion of the attach process, the handover control unit 606 receives notification that the attach process has been completed from the transmitting/receiving unit 602 and instructs the DHCP processing unit 605 to start IP address acquisition.

The DHCP processing unit 605 sends a DHCP discovery message to the access network 102 via the IP processing unit 603 and the transmitting/receiving unit 602, and receives a DHCP offer message including the allocated IPv4 address in response via the transmitting/receiving unit 602 and the IP processing unit 603. Furthermore, to receive the address allocation from the server, the DHCP processing unit 605 similarly transmits a DHCP request message and similarly receives a DHCP acknowledge message in response (IP address acquisition process: Step S703). The IP address acquisition process is completed by the above-described procedures, and the acquired IP address is configured in the IP processing unit 603.

At this time, the UE 107 receives the allocated address type notification message (such as a binding revocation request, a binding refresh request, a binding acknowledgement, or a message modified to be provided with a dedicated field or a dedicated flag) transmitted from the HA, via the handover source access network (access network 101) (Step S704). The allocated address type notification message is received via the transmitting/receiving unit 602 and the IP processing unit 603, and transferred to the MIP processing unit 604. The MIP processing unit 604 transfers or provides notification of the content of the allocated address type notification message to the home link judgment control unit 607.

The home link judgment control unit 607 evaluates the allocated address type notification message and detects whether the IP address acquired via the handover destination access network (access network 102) is a HoA or a CoA (Is notification content HoA?: Step S705). When the allocated address is the HoA, the home link judgment control unit 607 judges that the handover destination access network is the home link, and starts communication without performing the key exchange process or the binding process (BU/BA exchange) (Step S706). When the allocated address is the CoA, the home link judgment control unit 607 judges that the handover destination access network is an external link, and performs the key exchange process or the binding process (BU/BA exchange) as required (Step S707).

Finally, the handover control unit 606 instructs the transmitting/receiving unit 601 to start a detach process from the handover source network (access network 101) (Step S708), and completes the handover process with the completion of the detach process. The detach process may be omitted, or may be performed by an instruction being received from the network.

Here, when an IP address is allocated from the access network 102 during the attach process will be described. In this instance, the UE 107 is not required to perform DHCP-based IP address acquisition, and receives the allocated address type notification message from the handover source access network at almost the same timing as the completion of the attach process (the content of the message is transferred or notification thereof is provided to the home link judgment control unit 607 via the transmitting/receiving unit 601, the IP processing unit 603, and the MIP processing unit 604). Subsequent processes are the same as those described above, and therefore omitted herein.

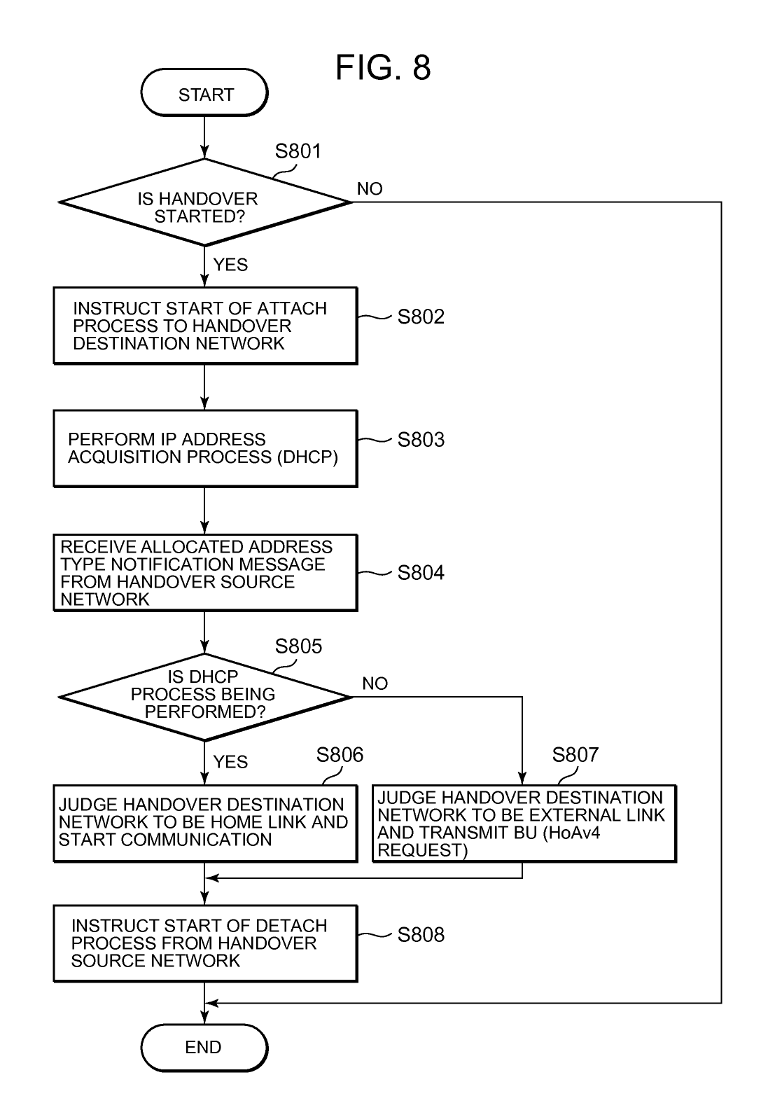

Next, an example of a process flow when the UE judges whether the HoA or the CoA has been allocated based on reception timing content of the allocated address type notification message from the HA will be described with reference to FIG. 8. The processes from the reception of the allocated address type notification message by the UE 107 via the handover source access network, to the transfer or notification of the content of the message to the home link judgment control unit 607 are the same as those described above. Therefore, descriptions thereof are omitted herein. As described above, the timing at which the allocated address type notification message is delivered to the UE 107 differs between HoA allocation and CoA allocation. Therefore, the UE 107 performs home link judgment taking advantage of this characteristic (see FIG. 2 to FIG. 5 regarding the differences in reception timing of the allocated address type notification message).

In other words, the home link judgment control unit 607 that has acquired the content of the allocated address type notification message judges whether the DHCP process is being performed (Step S805). When the DHCP process is being performed (when the judgment is YES), the home link judgment control unit 607 judges that the HoA has been allocated (judge handover destination network to be home link: Step S806). When a judgment is made otherwise (when the judgment is NO), the home link judgment control unit 607 judges that the CoA has been allocated (judge handover destination network to be external link: Step S807). Furthermore, when the home link judgment control unit 607 has already acquired the content of the allocated address type notification message before the completion of the DHCP process, the home link judgment control unit 607 can judge with certainty that the HoA has been allocated after confirming the content. When the home link judgment control unit 607 has received the allocated address type notification message before the completion of the DHCP process but the received allocated address type notification message is that indicating content that a CoA has been allocated, the home link judgment control unit 607 adheres to the content of the message.

Finally, the handover control unit 606 instructs the transmitting/receiving unit 601 to start a detach process from the handover source network (access network 101) (Step S808), and completes the handover process with the completion of the detach process. The detach process may be omitted or performed by an instruction being received from the network.

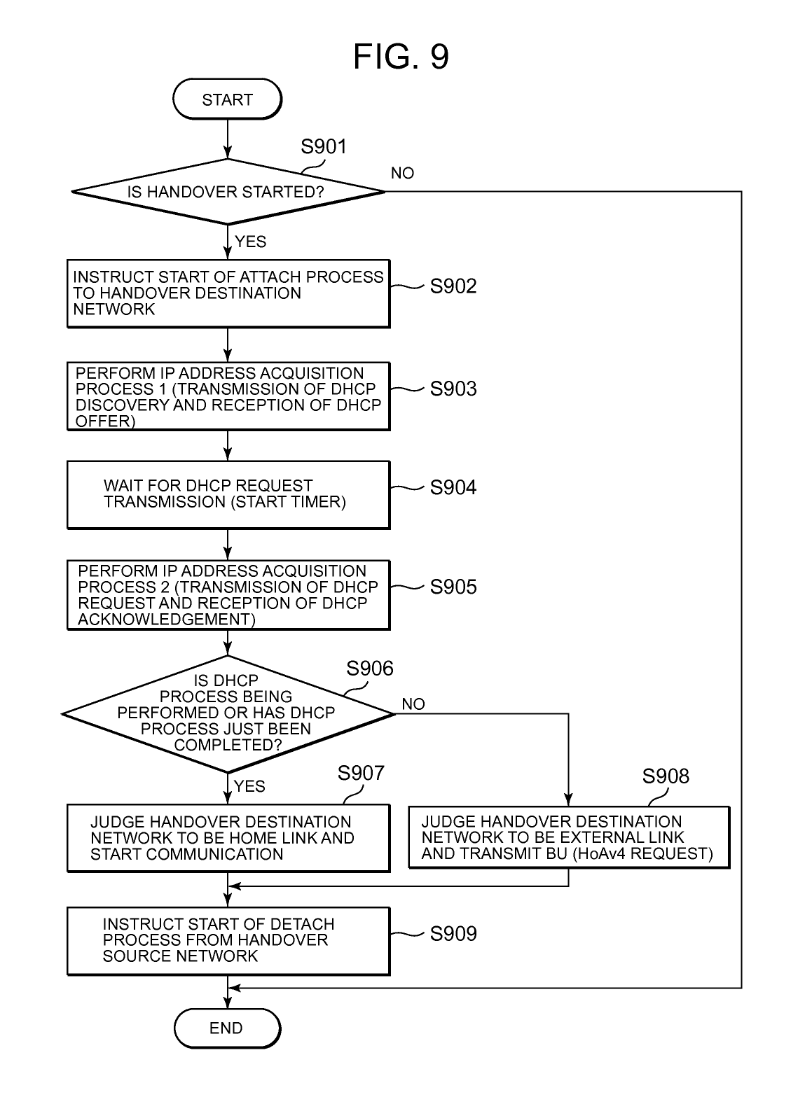

Furthermore, an example of an optimization process for removing the effects of transmission delay in the handover source access network when the UE judges whether an HoA or a CoA has been allocated based on the reception timing content of the allocated address type notification message from the HA will be described with reference to FIG. 9. The processes until the UE 107 attaches to the handover destination access network are the same as those described above. Therefore, descriptions thereof will be omitted herein. When the IP address is not allocated during the attach process, and the IP address is acquired using a protocol such as DHCP after completion of the attach process, the handover control unit 606 receives notification that the attach process has been completed from the transmitting/receiving unit 602 and instructs the DHCP processing unit 605 to start IP address acquisition.

The DHCP processing unit 605 transmits a DHCP discovery message to the access network 102 via the IP processing unit 603 and the transmitting/receiving unit 602, and receives a DHCP offer message including the allocated IPv4 address in response via the transmitting/receiving unit 602 and the IP processing unit 603 (IP address acquisition process 1: Step S903).

Here, because of jitter of transmission delay in the handover source access network, the HoA allocation that should be delivered before the CoA allocation may be delivered with a delay. To eliminate such effects, the DHCP processing unit 605 starts a timer (Step S904) and provides a predetermined amount of delay before the DHCP request message transmission. As the time value configured in the timer, for example, the result of measurement (average value or worst-case value) of a transmission delay value of the handover source access network measured by the UE 107, or a fixed value set in advance may be used. In addition, the time value may be configured in the DHCP processing unit 605 in advance, or may be configured (changed) for each DHCP process. In the latter instance, a delay value depending on the state of the network that dynamically changes can be configured, thereby increasing efficiency of the handover process.

To receive the address allocation from the server, after the elapse of the predetermined delay time, the DHCP request message is similarly transmitted and a DHCP acknowledge message is similarly received in response (IP acquisition process 2: Step S905). As a result of the above-described procedures, the IP address acquisition process is completed and the acquired IP address is configured in the IP processing unit 603. At this time, the allocated address type notification message transmitted by the HA 106 via the handover source access network (access network 101) is received by the UE 107, and is transferred or notification thereof is provided to the home link judgment control unit 607 by the above-described procedure.

The home link judgment control unit 607 that has acquired the content of the allocated address type notification message detects whether the DHCP process is being performed or has just been completed (for example, judgment can be made on completion of the DHCP process, or the judgment can be made by the time elapsed from the completion of the DHCP process being within a predetermined threshold or the like) based on the operating state of the DHCP processing unit 605 (Step S906). When the conditions match, the home link judgment control unit 607 judges that the HoA has been allocated (judge handover destination network to be home link: Step S907). When the conditions do not match, the home link judgment control unit 607 judges that the CoA has been allocated (judge handover destination network to be external link: Step S908). When the conditions match, or in other words, when the home link judgment control unit 607 has already acquired the content of the allocated address type notification message, the home link judgment control unit 607 can be more certain that the HoA has been allocated from the content. When the conditions match but the received allocated address type notification message is that indicating content that the CoA has been allocated, the home link judgment control_unit 607 adheres to the content of the message.

Finally, the handover control unit 606 instructs the transmitting/receiving unit 601 to start the detach process from the handover source network (access network 101) (Step S909), and completes the handover process with the completion of the detach process. The detach process may be omitted or performed by an instruction being received from the network.

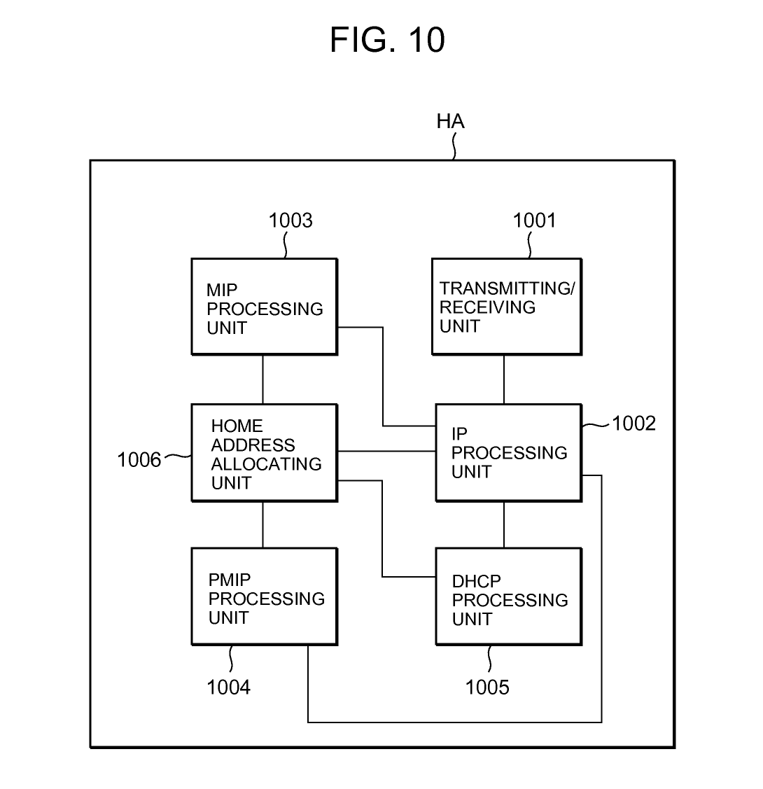

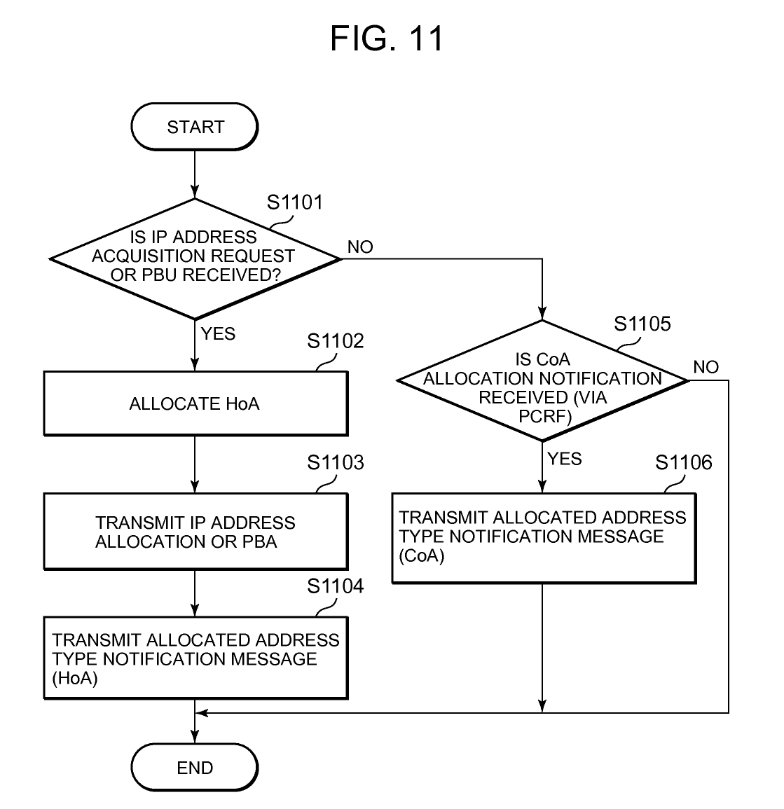

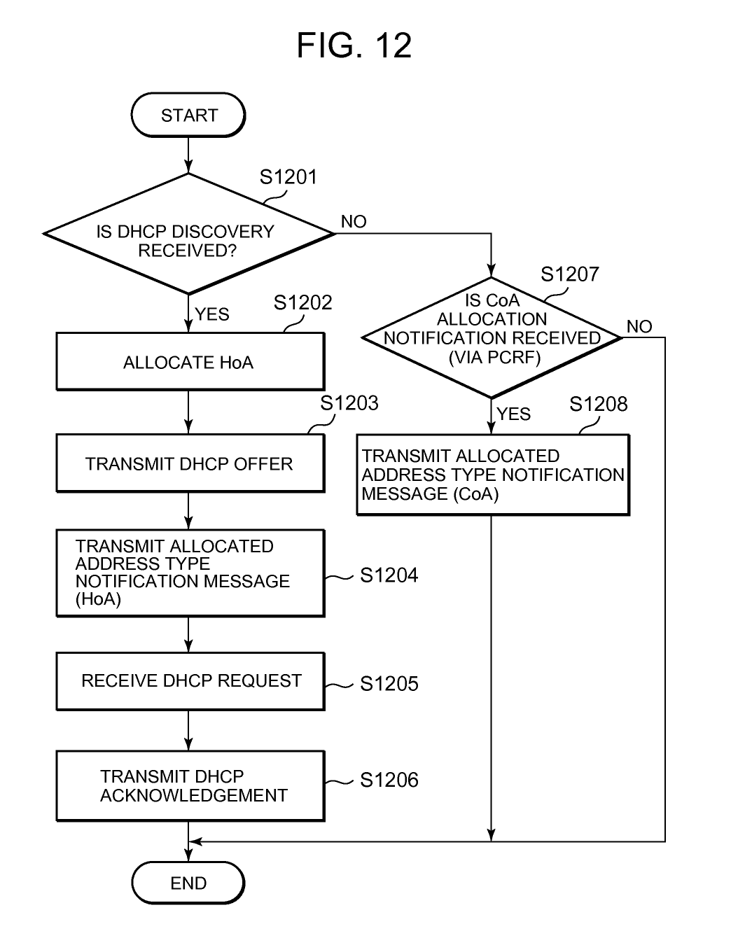

Next, an example of the operations of the home agent (HA) according to the embodiment of the present invention will be described with reference to FIG. 10 to FIG. 12. FIG. 10 is a configuration diagram for explaining an example of the configuration of the HA according to the embodiment of the present invention. A transmitting/receiving unit 1001 is equivalent to a communication interface for communicating with a node within the core network 103, and performs a communication protocol process and a modem process of layers below the IP layer. An IP processing unit 1002 performs the IP layer process, and an MIP processing unit 1003 performs a Mobile IP protocol process based on DSMIP. A PMIP processing unit 1004 performs the PMIP protocol process. A DHCP processing unit 1005 performs a DHCP protocol process (server function). A home address allocating unit 1006 is characteristic of the present invention, and an operation thereof will be described with operations of their periphery, with reference to FIG. 11 and FIG. 12.

FIG. 11 is a flowchart showing an example of a process flow of the HA when the UE judges whether a HoA or a CoA has been allocated based on the content of the allocated address type notification message received from the HA. Whether an IP address allocation request message (or a PBU message) from the UE 107 that had been transferred from the AR 105 has been transferred to the DHCP processing unit 1005 via the transmitting/receiving unit 1001 and the IP processing unit 1002 is judged (has IP address request or PBU been received?: Step S1101). When a judgment is made that the IP address allocation request message or the PBU has been received, the DHCP processing unit 1005 acquires the IP address to be allocated from the home address allocating unit 1006 (allocate HoA: Step S1102), includes the IP address in an IP address allocation message, and transmits the IP address allocation message via the IP processing unit 1002 and the transmitting/receiving unit 1001 (Step S1103). The IP address allocation message is then transferred to the UE 107 via the AR 105 operating as a DHCP relay. The home address allocating unit 1006 then transmits the allocated address type notification message via the AR 104 (Step S1104).

Here, the received IP address allocation request message includes the identifier (such as the network access identifier [NAI]) of the UE 107m and the HA 106 can identify that the message is a DHCP request from the UE 107. In addition, when the AR 105 transmits a proxy MIP PBU (proxy PBU) to the HA 106 after receiving the IP address allocation request message from the UE 107, the PMIP processing unit 1004 receives the PBU message via the transmitting/receiving unit 1001 and the IP processing unit 1002 and acquires the home address from the home address allocating unit 1006. The PMIP processing unit 1004 then writes the home address in a PBA message and transmits the PBA message. In this instance as well, because the PBU includes the identifier (such as the NAI) of the UE 107, the HA 106 can identify the message to be for address allocation to the UE 107.

The home address allocating unit 1006 transmits the allocated address type notification message via the handover source access network to the UE 107 based on the DSMIP binding information (held by the MIP processing unit 1003) generated by the UE 107, simultaneously with sending the home address based on the above-described DHCP protocol or PMIP protocol to the UE 107. Information indicating that the HoA has been allocated is written in the message. The address type notification message may be, for example, a binding revocation request, a binding refresh request, a binding acknowledgement, or a message modified to be provided with a dedicated field or a dedicated flag, that can be processed by the MIP processing unit 1003. Alternatively, a unique message may be prescribed.

In addition, whether notification has been received of transfer or arrival of a CoA allocation notification message transmitted by the PCRF server 108 to the home address allocating unit 1006 via the transmitting/receiving unit 1001 and the IP processing unit 1002 is judged (is CoA allocation notification received?: Step S1105). When a judgment is made that the notification has been received, the home address allocating unit 1006 transmits the allocated address type notification message to the UE 107 via the handover source access network, similarly based on the DSMIP binding information of the UE 107 (Step S1106). Information indicating that the CoA has been allocated is written in the message.

Next, an example of an HA process flow when the optimization process for removing the effects of transmission delay in the handover source access network is performed when the UE judges whether an HoA or a CoA has been allocated based on the reception timing content of the allocated address type notification message from the HA will be described with reference to FIG. 12. Whether a DHCP discovery message from the UE 107 that had been transferred from the AR 105 has been transferred to the DHCP processing unit 1005 via the transmitting/receiving unit 1001 and the IP processing unit 1002 is judged (is DHCP discovery received?: Step S1201). When a judgment is made that the DHCP discovery message has been transferred, the DHCP processing unit 1005 acquires the IP address to be allocated from the home address allocating unit 1006 (allocate HoA: Step S1203), includes the IP address in the DHCP offer message, and transmits the DHCP offer message via the IP processing unit 1002 and the transmitting/receiving unit 1001 (transmit DHCP offer: Step S1203).

The home address allocating unit 1006 then transmits the allocated address type notification message via the handover source access network to the UE 107 based on the DSMIP binding information (held by the MIP processing unit 1003) generated by the UE 107 (Step S1204). Information indicating that the HoA has been allocated is written in the message. Subsequently, the DHCP processing unit 1005 receives a DHCP request message from the UE 107 (receive DHCP request: Step S1205) and transmits a DHCP acknowledge message (transmit DHCP acknowledge: Step S1206). Here, to enable the allocation notification message to arrive at the UE 107 more quickly, Step S1204 may be performed before Step S1203.

In addition, whether notification has been received of transfer or arrival of a CoA allocation notification message transmitted by the PCRF server 108 to the home address allocating unit 1006 via the transmitting/receiving unit 1001 and the IP processing unit 1002 is judged (is CoA allocation notification received?: Step S1207). When a judgment is made that the notification has been received, the home address allocating unit 1006 transmits the allocated address type notification message to the UE 107 via the handover source access network, similarly based on the DSMIP binding information of the UE 107 (Step S1208). Information indicating that the CoA has been allocated is written in the message.

In the description above, use of the IP address allocation request message and the IP address allocation message by the mobile node to acquire the IP address is described. Here, the IP address allocation request message is a message that starts the IP address acquisition process, and is equivalent to the DHCP discovery message based on DHCP protocol, or the DHCP request message when the DHCP server is already known or transmission of the DHCP discovery message is omitted. The IP allocation message is a message for completing IP address allocation to the mobile node in the IP acquisition process and is equivalent to the DHCP acknowledge message based on DHCP protocol.

Each functional block used in the descriptions of the embodiment of the present invention, described above, can be actualized as a large scale integration (LSI) that is typically an integrated circuit. Each functional block can be individually formed into a single chip. Alternatively, some or all of the functional blocks can be included and formed into a single chip. Although referred to here as the LSI, depending on differences in integration, the integrated circuit can be referred to as the integrated circuit (IC), a system LSI, a super LSI, or an ultra LSI. The method of forming the integrated circuit is not limited to LSI and can be actualized by a dedicated circuit or a general-purpose processor. A field programmable gate array (FPGA) that can be programmed or a reconfigurable processor of which connections and settings of the circuit cells within the LSI can be reconfigured can be used after LSI manufacturing. Furthermore, if a technology for forming the integrated circuit that can replace LSI is introduced as a result of the advancement of semiconductor technology or a different derivative technology, the integration of the functional blocks can naturally be performed using the technology. For example, the application of biotechnology is a possibility.

### INDUSTRIAL APPLICABILITY

The handover method, and the mobile node and the home agent used in the handover method of present invention improve communication efficiency by early detecting that the handover destination access network is a home link and reducing the tunnel overhead between the mobile node and the home agent. In addition, even in an instance in which the mobile node performs a key update process, home link detection can be performed before the key update process, and packets can be transmitted and received in the network of the handover destination without waiting for the time-consuming key update process to be completed. As a result, the handover time can be reduced. In addition, through use of the DSMIP connection already established via the handover source access network, even when the handover destination network does not have a function for directly notifying the mobile node, the desired operations can be performed. Therefore, the present invention is useful as a handover method, and a mobile node and a home agent used in the handover method, and the like in a communication system in which communication is performed while moving between networks supporting different IP versions.

1. A handover method for a mobile node that moves between at least two networks each supporting a different, unique IP version that is a communication protocol of the mobile node, the handover method comprising the steps of:
transmitting, by the mobile node, when the mobile node performs a handover from an access router of a network before the handover to which the mobile node is currently connected, to an access router of another network that is a handover destination, an address allocation request message for acquiring an address in the handover destination network allocated to the mobile node, to the access network of the handover destination; and
transmitting, by a home agent of the mobile node, a notification message including information indicating a type of the address of the mobile node allocated by an address allocation server of the handover destination network or the home agent in response to the address allocation request message, to the mobile node via the access router before the handover.

2. The handover method according to claim 1, wherein the address allocation request message is a message used in a predetermined protocol to request address allocation.

3. The handover method according to claim 2, wherein the mobile node judges that a predetermined address has been allocated when the notification message is received immediately after reception of the address allocated based on the address allocation request message, or prior to the reception of the address.

4. The handover method according to claim 3, wherein the home agent transmits a response message for the address allocation request message to the mobile node in addition to the notification message, the response message including information indicating the type of the address allocated to the mobile node.

5. The handover method according to claim 1, wherein, when the address of the mobile node is allocated by the address allocation server of the handover destination network, the home agent receives information indicating the type of the allocated address from a predetermined server.

6. The handover method according to claim 2, wherein the home agent transmits a response message for the address allocation request message and simultaneously transmits the notification message.

7. The handover method according to claim 6, wherein the mobile node transmits a message in response to the response message after elapse of a predetermined amount of time after receiving the response message.

8. The handover method according to claim 5, wherein:
the address allocation server of the handover destination network transmits a response message in place of the home agent and simultaneously notifies the predetermined server of information indicating the type of the allocated address; and
the home agent transmits the notification message based on the information indicating the type of the allocated address.

9. The handover method according to claim 6, wherein the mobile node transmits the address allocation request message when the handover destination network or a communication network including the handover destination network is a network that meets predetermined conditions.

10. The handover method according to claim 1, wherein the type of the address is a home address or a care-of address.

11. A mobile node that performs a handover between at least two networks each supporting a different, unique IP version that is a communication protocol of the mobile node in which, when the mobile node performs a handover from an access router before the handover to which the mobile node is currently connected, to an access router of another network of a handover destination, the mobile node comprising:
a message generating means for generating an address allocation request message for acquiring an address in the network of the handover destination allocated to the mobile node;
a transmitting means for transmitting the generated address allocation request message to the access router of the handover destination; and
a receiving means for receiving, from a home agent of the mobile node via the access router before the handover, a notification message including information indicating a type of the address of the mobile node allocated by the address allocation server of the handover destination network or the home agent in response to the address allocation request message.

12. The mobile node according to claim 11, wherein the address allocation request message is a message used in a predetermined protocol to request address allocation.

13. The mobile node according to claim 12, further comprising a judging means for judging whether a predetermined address has been allocated, when the receiving means receives the notification message immediately after reception of the address allocated based on the address allocation request message or prior to the reception of the address.

14. The mobile node according to claim 13, wherein the receiving means receives a response message for the address allocation request message in addition to the notification message transmitted by the home agent, the response message including information indicating a type of the address allocated to the mobile node.

15. The mobile node according to claim 12, wherein the receiving means receives a response message for the address allocation request message and the notification message transmitted form the home agent.

16. The mobile node according to claim 15, wherein:
the message generating means generates a message in response to the response message after elapse of a predetermined amount of time after receiving the response message; and
the transmitting transmits the generated message responding to the response message.

17. The mobile node according to claim 15, wherein the response message is transmitted by the address allocation server of the handover destination in place of the home agent when the address of the mobile node is allocated by the address allocation server of the handover destination.

18. The mobile node according to claim 15, further comprising:
a confirming means for confirming whether the handover destination network or a communication network including the handover destination network is a network that meets predetermined conditions, wherein
the transmitting means transmits the address allocation request message when confirmation is made that the network meets the predetermined conditions.

19. The mobile node according to claim 11, wherein the type of the address is a home address or a care-of address.

20. A home agent of a mobile node that performs a handover between at least two networks each supporting a different, unique IP version that is a communication protocol of the mobile node in which, when the mobile node performs a handover from an access router before the handover to which the mobile node is currently connected, to an access router of another network of a handover destination, the home agent comprising:
a message generating means for generating a notification message inducing information indicating a type of an address of the mobile node allocated by an address allocating sever of the handover destination network or the home agent, based on an address allocation request message for acquiring an address in the handover destination network allocated to the mobile node; and
a transmitting means that transmits the generated notification message to the mobile node via the access router before the handover.

21. The home agent according to claim 20, wherein:
the message generating means generates a response message for the address allocation request message when the address allocation request message is a message used in a predetermined protocol to request address allocation; and
the transmitting means transits the notification message simultaneously with the response message.

22. The home agent according to claim 20, further comprising:
a receiving means for receiving, when the address of the mobile node is allocated by the address allocation server of the handover destination network, information indicating the type of the address allocated by the address allocation server of the handover destination network from a predetermined server of which notification is provided by the address allocation server of the handover destination network, wherein
the message generating means generates the notification message based on the information indicating the type of the allocated address, and
the transmitting means transmits the generated notification means.

23. The home agent according to claim 20, wherein the type of the address is a home address or a care-of address.
